(19) United States
(12) Patent Application Publication
(10) Pub. No.: US 2024/0334478 A1
(43) Pub. Date: Oct. 3, 2024

(54) SYSTEM AND METHOD FOR COORDINATED SPATIAL FREQUENCY REUSE IN WIRELESS COMMUNICATION

(71) Applicant: HUAWEI TECHNOLOGIES CO., LTD., Shenzhen (CN)

(72) Inventors: M Zulfiker ALI, Toronto (CA); Bo RAN, Shenzhen (CN); Hassan OMAR, Kanata (CA)

(21) Appl. No.: 18/738,474

(22) Filed: Jun. 10, 2024

Related U.S. Application Data
(63) Continuation of application No. PCT/CN2021/137991, filed on Dec. 14, 2021.

(51) Int. Cl. H04W 74/0808

(52) U.S. Cl. CPC H04W 74/0808

(57) ABSTRACT

The disclosed systems and methods for computing, by a first access point (AP), an allowable interference level for each station (STA) of a set of STAs scheduled by the first AP for a downlink (DL) transmission; computing, by the first AP, based on the allowable interference level for each scheduled STA, a corresponding power reduction parameter for each AP of a set of coordinated access points; selecting, by the first AP, based on the corresponding power reduction parameter, a subset of coordinated APs from the set of coordinated APs for a coordinated spatial frequency reuse; and transmitting, by the first AP, a coordination-trigger frame towards the subset of coordinated AP, wherein the coordination-trigger frame includes: the power reduction parameters corresponding to the APs included in the subset of coordinated APs, a predetermined DL transmission start time, and a predetermined maximum DL transmission duration.

### REFERENCE TO RELATED APPLICATIONS

This application is a continuation of International Patent Application Serial No. PCT/CN2021/137991, filed on Dec. 14, 2021, entitled “SYSTEM AND METHOD FOR COORDINATED SPATIAL FREQUENCY REUSE IN WIRELESS COMMUNICATION,” the contents of which are incorporated herein in their entirety by reference.

### TECHNICAL FIELD

The present disclosure generally relates to communication and, in particular, to a system, and a method for coordinated spatial frequency reuse in wireless communication.

### BACKGROUND

In recent years, a new Wi-Fi standard, referred to as the IEEE 802.11be (or Wi-Fi 7) standard has been under development. One of the main medium access control (MAC) features under consideration for the Wi-Fi 7 standard is coordinated transmit opportunity (Co-TXOP) sharing, which allows an access point (AP) that obtains a TXOP via channel contention to share its TXOP duration or bandwidth with a set of coordinated APs (Co-APs). When TXOP sharing is offered to each of the Co-APs, by a TXOP owner, the entire TXOP bandwidth is used for the entire TXOP duration. Such TXOP sharing is referred to as coordinated spatial frequency reuse (Co-SR).

By exploiting the TXOPs sharing with other Co-APs, Co-SR is expected to reduce the mean or standard deviation of the channel access delay and increase the goodput for a Co-AP. However, when Co-SR is employed, the duration of transmission of a physical layer protocol data unit (PPDU) by a TXOP owner AP may increase, due to PPDU transmission using a lower power or modulation and coding scheme (MCS) index. As well, the employment of Co-SR requires the exchange of control or overhead frames necessary for multi-AP coordination. Hence, TXOP sharing based on Co-SR creates a trade-off between the reduction of channel access delay and the increase of a PPDU transmission duration and additional control frame exchange.

There thus exists a need to further improve a total frame delivery delay and aggregate goodput when Co-SR is used in a wireless network.

### SUMMARY

The embodiments of the present disclosure have been developed based on developers' appreciation of shortcomings associated with the prior arts namely, a transmit opportunity (TXOP) sharing based on coordinated spatial frequency reuse (Co-SR) creates a trade-off between the reduction of channel access delay and the increase of a physical layer protocol data unit (PPDU) transmission duration and additional control frame exchange.

Developers of the present technology have devised an apparatus and methods for coordinated spatial frequency reuse in wireless communication. In particular, multiple access points (AP) in a wireless local area network (WLAN) may be scheduled to transmit signals over a given duration and a given bandwidth. However, only one of the multiple APs may be granted the TXOP via channel contention for transmission of data for a given duration over a given bandwidth. The AP that has been assigned the access to the channel is considered as TXOP owner AP. The TXOP owner AP may perform normal downlink (DL) station (STA) scheduling, resource unit (RU) allocation, and modulation and coding scheme (MCS) assignment operations. Accordingly, the TXOP owner AP may calculate the PPDU transmission duration and maximum allowed interference at the scheduled STA of the TXOP owner AP from the nearby APs. The TXOP owner AP may broadcast/multi-cast coordinated trigger (Co-trigger) frame and informs all the nearby APs of their maximum transmit power through the Co-trigger frame.

After receiving the Co-trigger frame, the APs that participate in the Co-SR also referred to as coordinated APs (Co-APs), the Co-APs may process the Co-trigger frame and may calculate DL transmission data rate for the associated scheduled STAs based on the maximum allowed power indicated in the Co-trigger frame by the TXOP owner AP. The Co-APs that participate in Co-SR process, start DL transmissions to the associated scheduled STAs without requesting for immediate acknowledgement from the STAs to avoid interference to the transmission from the TXOP owner AP.

In accordance with a first broad aspect of the present disclosure, there is provided a wireless communication method comprising: computing, by a first access point, an allowable interference level for each station (STA) of a set of STAs scheduled by the first access point for a downlink (DL) transmission; computing, by the first access point, based on the allowable interference level for each scheduled STA, a corresponding power reduction parameter for each access point of a set of coordinated access points; selecting, by the first access point, based on the corresponding power reduction parameter, a subset of coordinated access points from the set of coordinated access points for a coordinated spatial frequency reuse; and transmitting, by the first access point, a coordination-trigger frame towards the subset of coordinated access points, wherein the coordination-trigger frame includes: the power reduction parameters corresponding to the access points included in the subset of coordinated access points, a predetermined DL transmission start time, and a predetermined maximum DL transmission duration.

In accordance with other embodiments of the present disclosure, an allowable interference level, Iⱼ, corresponding to a j^{th} scheduled STA of the set of scheduled STAs is computed from (i) a received signal strength indicator (RSSI) Rⱼ received by the first access point in Radio Measurement Report frames from the j^{th} scheduled STA, each Radio Measurement Report frame providing a Beacon report, the Beacon report includes radio measurements of a beacon frame broadcast by the first access point, (ii) a required minimum value of DL signal-to-interference-plus-noise ratio (SINR) Sⱼ, at the j^{th} scheduled STA, and (iii) a margin M to account for RSSI Rⱼ variations.

In accordance with other embodiments of the present disclosure, the allowable interference level I; is given by: Iⱼ=Rⱼ−Sⱼ−M, where the Iⱼ and Rⱼ values are indicated in dBm and the Sⱼ value is indicated in dB.

In accordance with other embodiments of the present disclosure, the RSSI Rⱼ is stored in a management information base (MIB) of the first access point.

In accordance with other embodiments of the present disclosure, a power reduction parameter, Aₖ, corresponding to a k^{th} coordinated access point of the subset of coordinated access points is computed based on a minimum value of multiplicative constants αⱼ^{(k)} computed for the set of scheduled STAs, such that a power of the DL transmission from the k^{th} coordinated access point is reduced based on the power reduction parameter, Aₖ and an overall interference level at the j^{th} scheduled STA does not exceed the allowable interference level Iⱼ.

In accordance with other embodiments of the present disclosure, the power reduction parameter Aₖ is computed by: computing a multiplicative constant αⱼ^{(k)} for a transmit power of the k^{th} coordinated access point, such that:

$${\sum }_{k = 1}^{K} {r}_{j}^{( k )} {α}_{j}^{( k )} \leq {10}^{( \frac{{I}_{j}}{10} )}$$

where the rⱼ^{(k)} is an RSSI at the j^{th} scheduled STA corresponding to a beacon frame broadcast by the k^{th} coordinated access point, the rⱼ^{(k)} is extracted, by the first access point, from the Radio Measurement Report frames received from the j^{th} scheduled STA, or rⱼ^{(k)}=0, in case the k^{th} coordinated access point is not included in the Radio Measurement Report frames, K is a total number of coordinated access points in the set of coordinated access points located near the first access point, and a value of αⱼ^{(k)} is such that 0≤αⱼ^{(k)}≤1, j=1, . . . , N, N is a total number of STAs in the set of scheduled STAs; and computing the power reduction parameter Aₖ, in dB, based on 10 log

$$( {min}_{j} {α}_{j}^{( k )} ) .$$

In accordance with other embodiments of the present disclosure, when

$${min}_{j} {α}_{j}^{( k )} > 0$$

for the k^{th} coordinated access point, the k^{th} coordinated access point is selected by the first access point for a coordinated spatial frequency reuse.

In accordance with other embodiments of the present disclosure, the first access point obtains a channel access via channel contention among K+1 coordinated access points, for transmission of data for a given duration over a given bandwidth, wherein K is a total number of coordinated access points in the set of coordinated access points located near the first access point.

In accordance with a second broad aspect of the present disclosure, there is provided a wireless communication method comprising: receiving, by an n^{th} coordinated access point from a first access point, a coordination-trigger frame; extracting, by the n^{th} coordinated access point, information from the coordination-trigger frame; computing, by the n^{th} coordinated access point, a signal-to-interference-plus-noise ratio (SINR) expected at each station (STA) of a set of STAs scheduled by the n^{th} coordinated access point for a downlink (DL) transmission; determining, by the n^{th} coordinated access point, based on the SINR, a modulation and coding scheme (MCS) index to be employed for each scheduled STA of the set of STAs scheduled during a coordinated spatial frequency reuse; and performing, by the n^{th} coordinated access point, the DL transmission based on the information from the coordination-trigger frame and the MCS index.

In accordance with other embodiments of the present disclosure, a SINR Pₘ corresponding to an m^{th} scheduled STA is given by:

$${P}_{m} = {R}_{m} - {A}_{n} - 10 log {\sum }_{{k ∈ Q}_{k \neq n}} {r}_{m}^{( k )} {10}^{( \frac{{A}_{k}}{10} )} - M$$

where, Rₘ is a received signal strength indicator (RSSI) at the m^{th} scheduled STA corresponding to a beacon frame broadcast from the n^{th} coordinated access point -, the RSSI Rₘ being received by the n^{th} coordinated access point from the m^{th} scheduled STA in a Radio Measurement Report frame, including a Beacon Report, providing radio measurements of beacon frames received by the m^{th} scheduled STA, Q is a set of indices of coordinated access points selected by the first access point for the coordinated spatial frequency reuse, including the n^{th} coordinated access point and the first access point itself, rₘ^{(k)} is an RSSI at the m^{th} scheduled STA corresponding to a second beacon frame broadcast by a k^{th} coordinated access point, k∈Q, where the RSSI rₘ^{(k)} is extracted by the n^{th} coordinated access point from the Beacon Report included in the Radio Measurement Report frame received from the m^{th} scheduled STA, or rₘ^{(k)}=0, in case the k^{th} coordinated access point is not included in the Beacon Report, Aₙ is a corresponding power reduction parameter for the n^{th} coordinated access point, as determined by the first access point, Aₖ is the corresponding power reduction parameter for the k^{th} coordinated access point, as determined by the first access point for all k∈Q, and M is a margin to account for RSSI Rₘ variations.

In accordance with other embodiments of the present disclosure, the information in the received coordination-trigger frame includes: the power reduction parameter Aₖ∀k∈Q, a predetermined DL transmission start time, and a predetermined maximum DL transmission duration.

In accordance with other embodiments of the present disclosure, the n^{th} coordinated access point reduces a power of the DL transmission, based on the power reduction parameter Aₙ, during a period of the coordinated spatial frequency reuse.

In accordance with other embodiments of the present disclosure, the n^{th} coordinated access point starts the DL transmission towards the set of scheduled STAs in accordance with the DL transmission start time.

In accordance with other embodiments of the present disclosure, a start and an end of the DL transmission are defined by the DL transmission start time and the maximum DL transmission duration.

In accordance with other embodiments of the present disclosure, the DL transmission performed by the n^{th} coordinated access point includes a request for the set of scheduled STAs not to transmit any response frame during the coordinated spatial frequency reuse.

In accordance with other embodiments of the present disclosure, the DL transmission performed by the n^{th} coordinated access point includes a request for the set of scheduled STAs to delay a transmission of any response frame during the coordinated spatial frequency reuse.

In accordance with other embodiments of the present disclosure, the DL transmission performed by the n^{th} coordinated access point does not elicit any response frame during the coordinated spatial frequency reuse.

In accordance with other embodiments of the present disclosure, after the DL transmission within the maximum DL transmission duration, the n^{th} coordinated access point transmits block acknowledgment request frames to request the set of STAs scheduled during the coordinated spatial frequency reuse to transmit acknowledgment frames from the set of scheduled STAs towards the n^{th} coordinated access point.

In accordance with a third broad aspect of the present disclosure, there is provided wireless communication system comprising: a first access point configured to: compute an allowable interference level for each station (STA) of a set of STAs scheduled by the first access point for a downlink (DL) transmission; compute, based on the allowable interference level for each scheduled STA, a corresponding power reduction parameter for each access point of a set of coordinated access points; select, based on the corresponding power reduction parameter, a subset of coordinated access points from the set of coordinated access points for a coordinated spatial reuse; and transmit a coordination-trigger frame towards the subset of coordinated access points, wherein the coordination-trigger frame includes: the power reduction parameters corresponding to the access points included in the subset of coordinated access points, a predetermined DL transmission start time, and a predetermined maximum DL transmission duration.

In accordance with other embodiments of the present disclosure, an allowable interference level, Iⱼ, corresponding to a j^{th} scheduled STA of the set of scheduled STAs is computed from (i) a received signal strength indicator (RSSI) Rⱼ received by the first access point in Radio Measurement Report frames from the j^{th} scheduled STA, each Radio Measurement Report frame providing a Beacon report, the Beacon report includes radio measurements of a beacon frame broadcast by the first access point, (ii) a required minimum value of DL signal-to-interference-plus-noise ratio (SINR) Sⱼ, at the j^{th} scheduled STA, and (iii) a margin M to account for RSSI Rⱼ variations.

In accordance with other embodiments of the present disclosure, the allowable interference level Iⱼ is given by: Iⱼ=Rⱼ−Sⱼ−M, where the Iⱼ and Rⱼ values are indicated in dBm and the Sⱼ value is indicated in dB.

In accordance with other embodiments of the present disclosure, the RSSI Rⱼ is stored in a management information base (MIB) of the first access point.

In accordance with other embodiments of the present disclosure, a power reduction parameter, Aₖ, corresponding to a k^{th} coordinated access point of the subset of coordinated access points is computed based on a minimum value of multiplicative constants αⱼ^{(k)} computed for the set of scheduled STAs, such that a power of the DL transmission from the k^{th} coordinated access point is reduced based on the power reduction parameter, Aₖ and an overall interference level at the j^{th} scheduled STA does not exceed the allowable interference level Iⱼ.

In accordance with other embodiments of the present disclosure, the power reduction parameter Aₖ is computed by: computing a multiplicative constant αⱼ^{(k)} for a transmit power of the k^{th} coordinated access point, such that:

$${\sum }_{k = 1}^{K} {r}_{j}^{( k )} {α}_{j}^{( k )} \leq {10}^{( \frac{{I}_{j}}{10} )}$$

where the rⱼ^{(k)} is an RSSI at the j^{th} scheduled STA corresponding to a beacon frame broadcast by the k^{th} coordinated access point, the rⱼ^{(k)} is extracted, by the first access point, from the Radio Measurement Report frames received from the j^{th} scheduled STA, or rⱼ^{(k)}=0, in case the k^{th} coordinated access point is not included in the Radio Measurement Report frames, K is a total number of coordinated access points in the set of coordinated access points located near the first access point, and a value of αⱼ^{(k)} is such that 0≤αⱼ^{(k)}≤1, j=1, . . . , N, N is a total number of STAs in the set of scheduled STAs; and computing the power reduction parameter Aₖ, in dB, based on 10 log

$${P}_{m} = {R}_{m} - {A}_{n} - 10 log {\sum }_{{k ∈ Q}_{k \neq n}} {r}_{m}^{( k )} {10}^{( \frac{{A}_{k}}{10} )} - M$$

In accordance with other embodiments of the present disclosure, when

$${min}_{j} {α}_{j}^{( k )} > 0$$

for the k^{th} coordinated access point, the k^{th} coordinated access point is selected by the first access point for a coordinated spatial frequency reuse.

In accordance with other embodiments of the present disclosure, the first access point obtains a channel access via channel contention among K+1 coordinated access points, for transmission of data for a given duration over a given bandwidth, wherein K is a total number of coordinated access points in the set of coordinated access points located near the first access point.

In accordance with a fourth broad aspect of the present disclosure, there is provided wireless communication system comprising: an n^{th} coordinated access point configured to: receive a coordination-trigger frame from a first access point; extract information from the coordination-trigger frame; compute a signal-to-interference-plus-noise ratio (SINR) expected at each station (STA) of a set of STAs scheduled by the n^{th} coordinated access point for a down link (DL) transmission; determine, based on the SINR, a modulation and coding scheme (MCS) index to be employed for each scheduled STA of the set of STAs scheduled during a coordinated spatial frequency reuse; and perform the DL transmission based on the information from the coordination-trigger frame and the MCS index.

In accordance with other embodiments of the present disclosure, a SINR Pₘ corresponding to an m^{th} scheduled STA is given by:

$${P}_{m} = {R}_{m} - {A}_{n} - 10 log {\sum }_{{k ∈ Q}_{k \neq n}} {r}_{m}^{( k )} {10}^{( \frac{{A}_{k}}{10} )} - M$$

where, Rₘ is a received signal strength indicator (RSSI) at the m^{th} scheduled STA corresponding to a beacon frame broadcast from the n^{th} coordinated access point, the RSSI Rₘ being received by the n^{th} coordinated access point from the m^{th} scheduled STA in a Radio Measurement Report frame, including a Beacon report, providing radio measurements of beacon frames received by the m^{th} scheduled STA, Q is a set of indices of coordinated access points selected by the first access point for the coordinated spatial frequency reuse, including the n^{th} coordinated access point and the first access point itself, rₘ^{(k)} is an RSSI at the m^{th} scheduled STA corresponding to a second beacon frame broadcast by a k^{th} coordinated access point, k∈Q, where the RSSI rₘ^{(k)} is extracted by the n^{th} coordinated access point from the Beacon Report included in the Radio Measurement Report frame received from the m^{th} scheduled STA, or rₘ^{(k)}=0, in case the k^{th} coordinated access point is not included in the Beacon Report, Aₙ is a corresponding power reduction parameter for the n^{th} coordinated access point, as determined by the first access point, Aₖ is the corresponding power reduction parameter for the k^{th} coordinated access point, as determined by the first access point for all k∈Q, and M is a margin to account for RSSI Rₘ variations.

In accordance with other embodiments of the present disclosure, the information in the received coordination-trigger frame includes: the power reduction parameter Aₖ∀k∈Q, a predetermined DL transmission start time, and a predetermined maximum DL transmission duration.

In accordance with other embodiments of the present disclosure, the n^{th} coordinated access point reduces a power of the DL transmission, based on the power reduction parameter Aₙ, during a period of the coordinated spatial frequency reuse.

In accordance with other embodiments of the present disclosure, the n^{th} coordinated access point starts the DL transmission towards the set of scheduled STAs in accordance with the DL transmission start time.

In accordance with other embodiments of the present disclosure, a start and an end of the DL transmission are defined by the DL transmission start time and the maximum DL transmission duration.

In accordance with other embodiments of the present disclosure, the DL transmission performed by the n^{th} coordinated access point requests the set of scheduled STAs not to transmit any response frame during the coordinated spatial frequency reuse.

In accordance with other embodiments of the present disclosure, the DL transmission performed by the n^{th} coordinated access point includes a request for the set of scheduled STAs to delay a transmission of any response frame during the coordinated spatial frequency reuse.

In accordance with other embodiments of the present disclosure, the DL transmission performed by the n^{th} coordinated access point does not elicit any response frame during the coordinated spatial frequency reuse.

In accordance with other embodiments of the present disclosure, after the DL transmission within the maximum DL transmission duration, the n^{th} coordinated access point transmits block acknowledgment request frames to request the set of STAs scheduled during the coordinated spatial frequency reuse to transmit acknowledgment frames from the set of scheduled STAs towards the n^{th} coordinated access point.

In accordance with a fifth broad aspect of the present disclosure, there is provided a coordinated access point comprising: a non-transitory memory element having instructions thereon; a processor coupled to the non-transitory memory element and execute the instructions to cause the coordinated access point to: compute an allowable interference level for each station (STA) of a set of STAs scheduled by the first access point for a downlink (DL) transmission; compute, based on the allowable interference level for each scheduled STA, a corresponding power reduction parameter for each access point of a set of coordinated access points; select, based on the corresponding power reduction parameter, a subset of coordinated access points from the set of coordinated access points for a coordinated spatial reuse; and transmit a coordination-trigger frame towards the subset of coordinated access points, wherein the coordination-trigger frame includes: the power reduction parameters corresponding to the access points included in the subset of coordinated access points, a predetermined DL transmission start time, and a predetermined maximum DL transmission duration.

In accordance with a sixth broad aspect of the present disclosure, there is provided coordinated access point comprising: a non-transitory memory element having instructions thereon; a processor coupled to the non-transitory memory element and execute the instructions to cause the coordinated access point to: receive a coordination-trigger frame; extract information from the coordination-trigger frame; compute a signal-to-interference-plus-noise ratio (SINR) expected at each station (STA) of a set of STAs scheduled by the coordinated access point for a down link (DL) transmission; determine, based on the SINR, a modulation and coding scheme (MCS) index to be employed for each scheduled STA of the set of STAs scheduled during a coordinated spatial frequency reuse; and perform the DL transmission based on the information from the coordination-trigger frame and the MCS index.

### BRIEF DESCRIPTION OF THE FIGURES

Further features and advantages of the present disclosure will become apparent from the following detailed description, taken in combination with the appended drawings, in which:

FIG. 1A illustrates an environment of a wireless local area network (WLAN), in accordance with various embodiments of the present disclosure;

FIG. 1B illustrates a high-level functional block diagram of an access point (AP), in accordance with various non-limiting embodiments of the present disclosure;

FIG. 2 illustrates an example channel access by the transmit opportunity (TXOP) owner AP and the coordinated AP (Co-AP);

FIG. 3 illustrates a portion of the WLAN, in accordance with various non-limiting embodiments of the present disclosure;

FIG. 4 depicts a flowchart representing a method for wireless communication, in accordance with various non-limiting embodiments of the present disclosure;

FIG. 5 depicts a process representing another method for wireless communication, in accordance with various non-limiting embodiments of the present disclosure;

FIG. 6 illustrates a representative timeline corresponding to the DL PPDU transmissions by the TXOP owner AP and the Co-AP, in accordance with various non-limiting embodiments of the present disclosure;

FIG. 7 illustrates another portion of the WLAN, in accordance with various non-limiting embodiments of the present disclosure;

FIGS. 8A-8J illustrate an average packet delivery delay and a probability of a successful Co-SR attempt for various simulation scenarios, in accordance with various non-limiting embodiments of the present disclosure; and

FIGS. 9A-9F illustrate further analysis of various simulation scenarios, in accordance with various non-limiting embodiments.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims.

### DETAILED DESCRIPTION

The instant disclosure is directed to address at least some of the deficiencies of the current technology. In particular, the instant disclosure describes an apparatus and a method for coordinated spatial frequency reuse in wireless communication.

Unless otherwise defined or indicated by context, all technical and scientific terms used herein have the same meaning as commonly understood by one of ordinary skill in the art to which the described embodiments appertain to.

In the context of the present specification, “Wi-Fi apparatus” is any computer hardware that is capable of running software appropriate to the relevant task at hand. In the context of the present specification, in general the term “Wi-Fi apparatus” is associated with a user of the Wi-Fi apparatus. Thus, some (non-limiting) examples of Wi-Fi apparatus include personal computers (desktops, laptops, netbooks, etc.), smartphones, and tablets, as well as network equipment such as routers, switches, modems and gateways. It should be noted that an apparatus acting as a Wi-Fi apparatus in the present context is not precluded from acting as an access point to other Wi-Fi apparatuses.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the server, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

It will be understood that when an element is referred to as being “connected” or “coupled” to another element, it can be directly or indirectly connected or coupled to the other element or intervening elements that may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the context of the present specification, when an element is referred to as being “associated with” another element, in certain embodiments, the two elements can be directly or indirectly linked, related, connected, coupled, the second element employs the first element, or the like without limiting the scope of present disclosure.

The terminology used herein is only intended to describe particular representative embodiments and is not intended to be limiting of the present technology. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the context of the present disclosure, the expression “data” includes data of any nature or kind whatsoever capable of being stored in a database. Thus, data includes, but is not limited to, audiovisual works (images, movies, sound records, presentations etc.), data (location data, numerical data, etc.), text (opinions, comments, questions, messages, etc.), documents, spreadsheets, etc.

Software modules, modules, or units which are implied to be software, may be represented herein as any combination of flowchart elements or other elements indicating performance of process steps and/or textual description. Such modules may be executed by hardware that is expressly or implicitly shown.

With these fundamentals in place, the instant disclosure is directed to address at least some of the deficiencies of the current technology. In particular, the instant disclosure describes an apparatus and a method for coordinated spatial frequency reuse in wireless communication.

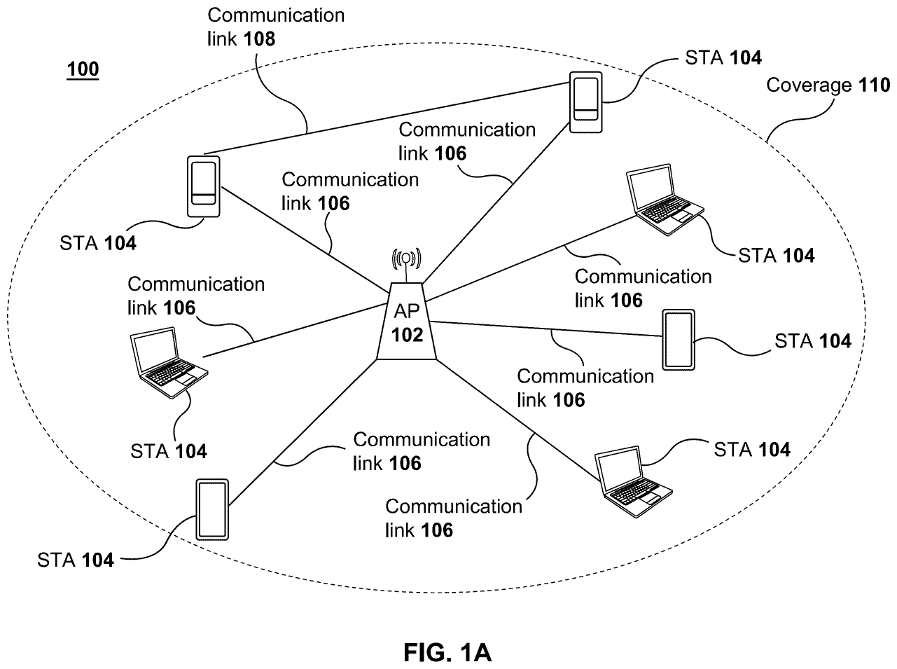

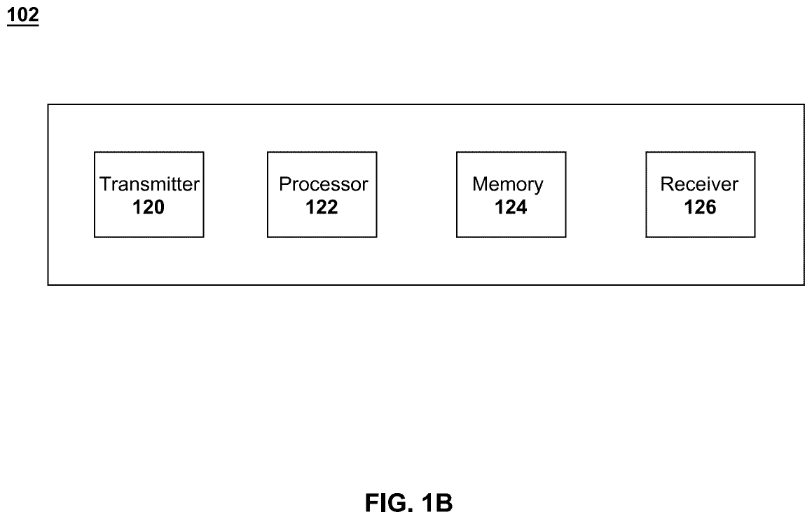

FIG. 1A illustrates an environment of a wireless local area network (WLAN) 100, in accordance with various embodiments of the present disclosure. The WLAN 100 may include several wireless devices such as an access point (AP) 102 and multiple associated stations (STAs) 104. Each of the STAs 104 may also be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), printers or the like. In other words, the STAs 104 may be any electronic device capable of wirelessly communicating with other electronic devices and/or AP 102. In certain non-limiting embodiments, the WLAN 100 may be a network implementing at least one of the IEEE 802.11 family of standards.

In certain non-limiting embodiments, each of the STAs 104 may associate and communicate with the AP 102 via a communication link 106. The various STAs 104 in the network are able to communicate with one another through the AP 102. A single AP 102 and an associated set of STAs 104 may be referred to as a basic service set (BSS). FIG. 1A additionally shows an example coverage area 110 of the AP 102, which may represent a basic service area (BSA) of the WLAN 100. While only one AP 102 is shown, the WLAN 100 may include multiple APs 102. An extended service set (ESS) may include a set of connected BSSs. An extended network station associated with the WLAN 100 may be connected to a wired or wireless distribution system that may allow multiple APs 102 to be connected in such an ESS. As such, a STA 104 may be covered by more than one AP 102 and may associate with different APs 102 at different times for different transmissions.

In certain non-limiting embodiments, the STAs 104 may function and communicate (via the respective communication links 106) according to the IEEE 802.11 family of standards and amendments including, but not limited to, 802.11a, 802.11b, 802.11g, 802.11n, 802.11ac, 802.11ad, 802.11ah, 802.11af, 802.1lay, 802.11ax, 802.11az, 802.11ba, and 802.11be. These standards define the WLAN radio and baseband protocols for the PHY and medium access control (MAC) layers. The STAs 104 in the WLAN 100 may communicate over an unlicensed spectrum, which may be a portion of the spectrum that includes frequency bands traditionally used by Wi-Fi technology, such as the 2.4 GHz band, and the 5 GHz band. The unlicensed spectrum may also include other frequency bands, such as the emerging 6 GHz band. The STAs 104 in the WLAN 100 may also be configured to communicate over other frequency bands such as shared licensed frequency bands, where multiple operators may have a license to operate in the same or overlapping frequency band or bands.

In certain non-limiting embodiments, the STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also may communicate directly with each other via direct wireless communication links 108. Additionally, two STAs 104 may communicate via a direct wireless communication link 108 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 108 include Wi-Fi Direct connections, connections established by using a Wi-Fi Tunneled Direct Link Setup (TDLS) link, and other peer-to-peer (P2P) group connections.

In certain non-limiting embodiments, some types of STAs 104 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that may make use of the information or present the information to humans interacting with the program or application.

In certain non-limiting embodiments, WLAN 100 may support beamformed transmissions. As an example, AP 102 may use multiple antennas or antenna arrays to conduct beamforming operations for directional communications with a STA 104. Beamforming (which may also be referred to as spatial filtering or directional transmission) is a signal processing technique that may be used at a transmitter (e.g., AP 102) to shape and/or steer an overall antenna beam in the direction of a target receiver (e.g., a STA 104).

In certain non-limiting embodiments, WLAN 100 may further support multiple-input, multiple-output (MIMO) wireless systems. Such systems may use a transmission scheme between a transmitter (e.g., AP 102) and a receiver (e.g., a STA 104), where both transmitter and receiver are equipped with multiple antennas. For example, AP 102 may have an antenna array with a number of rows and columns of antenna ports that the AP 102 may use for beamforming in its communication with a STA 104. Signals may be transmitted multiple times in different directions (e.g., each transmission may be beamformed differently). The receiver (e.g., STA 104) may try multiple beams (e.g., antenna subarrays) while receiving the signals.

Typically, among multiple APs 102 only one AP is selected using channel contention to transmit data to one or more STAs 104. However, with recent advancement in IEEE 802.11be (or Wi-Fi 7) standard, a coordinated transmit opportunity (Co-TXOP) sharing has been proposed. The Co-TXOP allows the AP 102, which has been selected using channel contention (also referred to as TXOP owner AP 102), to share the TXOP duration and/or bandwidth with a set of coordinated APs (Co-APs) 102.

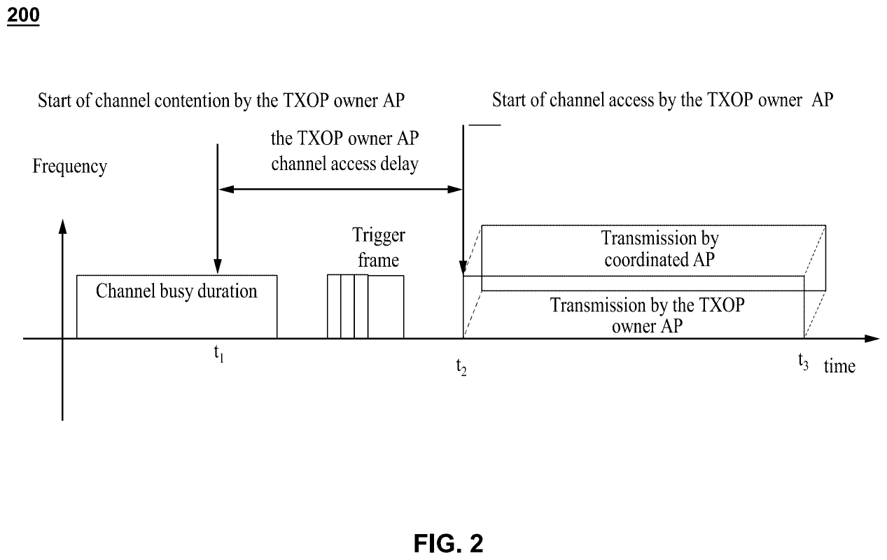

FIG. 1B illustrates a high-level functional block diagram of the AP 102, in accordance with various non-limiting embodiments of the present disclosure. As shown, the AP 102 may include a transmitter 120, a processor 122, a memory 124 and a receiver 126. It is to be noted that the AP 102 may include other components, however, such components have been omitted from FIG. 2 for the purpose of simplicity.

In certain non-limiting embodiments, the transmitter 120 and the receiver 126 may communicate with other APs and STAs in the WLAN 100 over the communication link 106. Further, the memory 124 including a non-transitory portion may store instructions to be implemented by the processor 122 to implement various non-limiting embodiments of the present disclosure. Also, the transmitter 120, the processor 122, the memory 124 and the receiver 126 may be communicably connected with each other.

FIG. 2 illustrates an example 200 of channel access by the TXOP owner AP 102 and the Co-AP 102. As shown, the TXOP owner AP 102 initiates a channel contention at time t₁. At time t₂, channel access to the TXOP owner AP 102 is granted for data transmission. The time between t₂ and t₁ represents a channel access delay. During the channel access delay, the TXOP owner AP 102 transmits trigger frame towards the Co-APs 102. At time t₂ the TXOP owner AP 102 and the Co-AP 102 transmits on same bandwidth and same time. Sharing of the TXOP duration and/or bandwidth by the TXOP owner AP 102 with the Co-APs 102 is referred to as coordinated spatial frequency reuse (Co-SR).

The Co-SR reduces packet delivery delay for the Co-AP 102 by reducing the average or standard deviation (STD) of channel access delay. Otherwise, the Co-AP 102 may have to wait to access the channel at least while the TXOP owner AP 102 is transmitting over the channel. Such improvement in channel access delay (average or STD) results in a reduction of the worst-case channel access delay, which is a crucial quality-of-service (QOS) requirement for real-time and delay sensitive applications. Additionally, a decrease in the channel access delay for different Co-APs 102 results in an improvement in the aggregate goodput. However, it is to be noted that in order to achieve the expected gains from Co-SR, multi-AP coordination involves a trade-off between the reduction in channel access delay and the increase in physical layer protocol data unit (PPDU) transmission duration and control overhead. With this said, various non-limiting embodiments of the present disclosure are directed towards further improving the performance of the WLAN 100 during Co-SR.

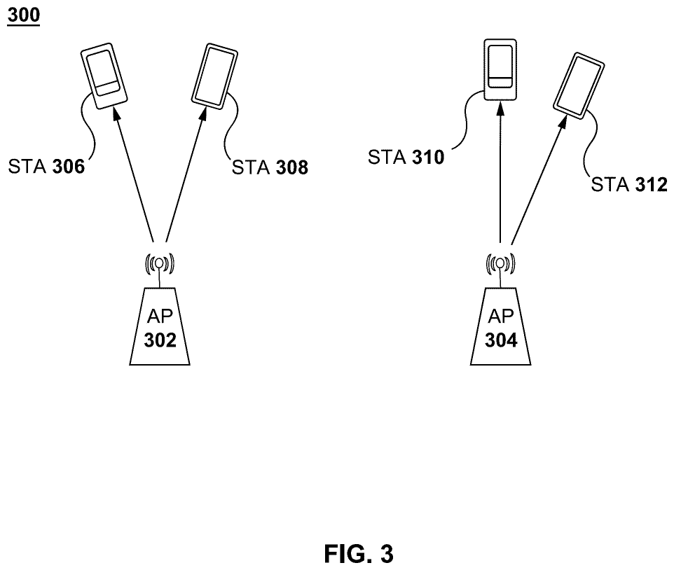

FIG. 3 illustrates a portion 300 of the WLAN 100, in accordance with various non-limiting embodiments of the present disclosure. As shown, the portion 300 may include APs 302 and 304, STAs 306, 308, 310 and 312. The STAs 306 and 308 may be associated with the AP 302 and the STAs 310 and 312 may be associated with the AP 304. It is to be noted that for the purpose of simplicity two APs 302 and 304 and four STAs 306, 308, 310 and 312 have been illustrated. In various non-limiting embodiments, the WLAN 100 may include K+1 APs, where K+1 is a total number of APs in the WLAN 100. Also, with each AP there may be N associated STAs. Further, it is contemplated that the APs 302 and 304 may be implemented in a similar manner to the AP 102 and the STAs 306, 308, 310 and 312 may be implemented in a similar manner to the AP 102 as previously discussed in FIG. 1B.

In certain non-limiting embodiments, the K+1 APs in the WLAN 100, may be scheduled to transmit signals over a given duration and a given bandwidth. However, only one of the K+1 APs may be granted TXOP via channel contention for transmission of data for a given duration over a given bandwidth. In FIG. 3, as an example, AP 302 may be considered as TXOP owner AP 302. The TXOP owner AP 302 may perform normal downlink (DL) STA scheduling, resource unit (RU) allocation, and modulation and coding scheme (MCS) assignment operations. Accordingly, the TXOP owner AP 302 may calculate the PPDU transmission duration and maximum allowed interference at the scheduled STA (e.g., STA 306) of the TXOP owner AP 302 from the nearby APs (e.g., AP 304). The TXOP owner AP 302 may broadcast/multi-cast coordinated trigger (Co-trigger) frame and informs all the nearby APs (e.g., AP 304) of their maximum transmit power through the Co-trigger frame.

After receiving the Co-trigger frame, the APs (e.g., AP 304) that participate in the Co-SR also referred to as Co-APs, the Co-APs (e.g., AP 304) may process the Co-trigger frame and may calculate DL transmission data rate for the associated scheduled STAs (e.g., STAs 310 and 312) based on the maximum allowed power indicated in the Co-trigger frame by the TXOP owner AP 302. The Co-APs (e.g., AP 304) that participate in Co-SR process, start DL transmissions to the associated scheduled STAs (e.g., STAs 310 and 312) without requesting for immediate acknowledgement from the STAs (e.g., STAs 310 and 312) to avoid interference to the transmission from the TXOP owner AP 302.

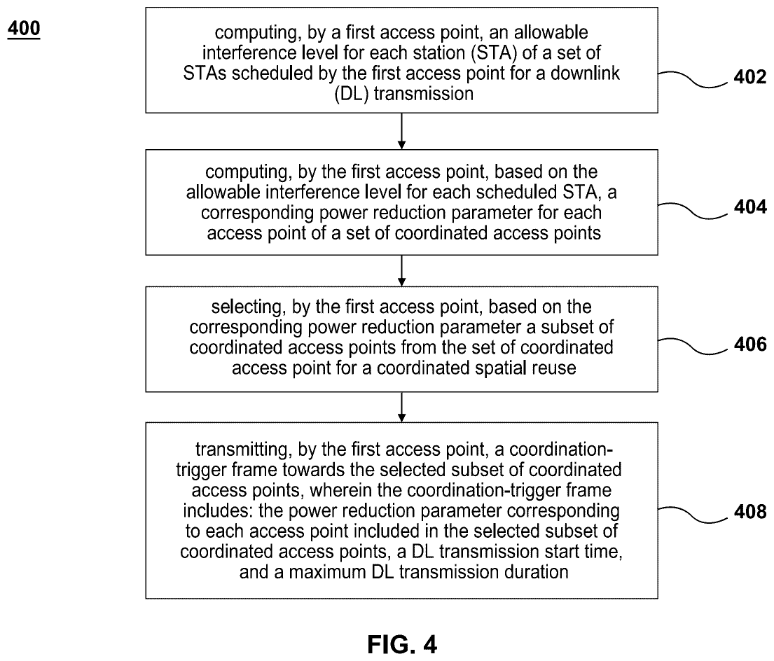

FIG. 4 depicts a process 400 representing a method for wireless communication, in accordance with various non-limiting embodiments of the present disclosure. In certain non-limiting embodiments, the process 400 may be implemented on the TXOP owner AP 302 (as shown in FIG. 3). As shown, the process 400 commences at step 402 where the TXOP owner AP 302 computes an allowable interference level for each station (STA) of a set of STAs (e.g., STA 306 and 308) scheduled by the TXOP owner AP 302 for a downlink (DL) transmission.

In certain non-limiting embodiments, the TXOP owner AP 302 may compute an allowable interference level Iⱼ, corresponding to a j^{th} scheduled STA (e.g., STA 306) of the set of scheduled STAs (e.g., STA 306 and 308). The j^{th} scheduled STA (e.g., STA 306) may calculate a received signal strength indicator (RSSI) Rⱼ of a beacon frame broadcast by the TXOP owner AP 302. In certain non-limiting embodiments, the RSSI Rⱼ may be calculated by the j^{th} scheduled STA (e.g., STA 306) from beacon frames broadcast by the TXOP owner AP 302. The RSSI Rⱼ may be received by the TXOP owner AP 302 in Radio Measurement Report frames from the j^{th} scheduled STA, each Radio Measurement Report frame providing a Beacon report, the Beacon report includes radio measurements of the latest beacon frame broadcast by the TXOP owner AP 302 towards the j^{th} scheduled STA (e.g., STA 306).

For the j^{th} scheduled STA (e.g., STA 306), the TXOP owner AP 302 may obtain a minimum required DL signal-to-interference plus noise ratio (SINR), denoted by Sⱼ. The SINR Sⱼ may be based on the MCS index selected for the j^{th} scheduled STA (e.g., STA 306), ∀j=1, . . . , N, where N indicates the number of scheduled STAs (e.g., STAs 306 and 308).

In certain non-limiting embodiments, the TXOP owner AP 302 may compute the allowable interference level Iⱼ from (i) the RSSI Rⱼ, (ii) the SINR Sⱼ and (iii) a margin M to account for RSSI Rⱼ variations, e.g., M=3 dBm.

For the j^{th} scheduled STA (e.g., STA 306), the TXOP owner AP 302 may calculate the maximum allowed interference level Iⱼ, j=1, . . . , N, such that:

$${I}_{j} = {R}_{j} - {S}_{j} - M \qquad ( 1 )$$

where the Iⱼ, and Rⱼ values are indicated in dBm and the Sⱼ value is indicated in dB. It is to be noted that, the value of RSSI Rⱼ may be known to the TXOP owner AP 302 as a result of Radio Measurement Report frames that may be periodically sent by the j^{th} scheduled STA (e.g., STA 306).

It is contemplated that each AP (e.g., AP 302 and 304) may maintain and store a Co-SR management information base (MIB) as shown in Table 1, where rⱼ^{(k)} indicating the RSSI at the j^{th} STA (e.g., STA 306) corresponding to a beacon frame transmitted by a k^{th} Co-AP (e.g., AP 304), as derived from the Radio Measurement Report frames sent by the j^{th} associated STA (e.g., STA 306), where, j=1, . . . , C and k=1, . . . , K. C may be a total number of STAs associated with the AP that maintains the MIB. K may be a total number of Co-APs in the set of Co-APs located near the AP that maintains the MIB.

TABLE 1
MIB

| | BSS member STA index | | | |
|---|---|---|---|---|
| Co-AP index | 1 | 2 | . . . | C |
| 1 | r⁽¹⁾₁ | r⁽¹⁾₂ | | r⁽¹⁾_{C} |
| . | . | . | . | . |
| . | . | . | . | . |
| . | . | . | . | . |
| K | r^{(K)}₁ | r^{(K)}₂ | | r^{(K)}_{C} |

After calculating the maximum allowed interference Iⱼ at the j^{th} scheduled STA (e.g., STA 306), the process 400 proceeds to step 404 where the TXOP owner AP 302, based on the allowable interference level Iⱼ for each scheduled STA (e.g., STA 306 and 308), computes a power reduction parameter Aₖ corresponding to each access point of the set of Co-APs (e.g., AP 304).

To compute the power reduction parameter Aₖ, in certain non-limiting embodiments, for the k^{th} Co-AP (e.g., AP 304) and the j^{th} scheduled STA (e.g., STA 306), the TXOP owner AP 302 may compute a multiplication factor αⱼ^{(k)} to determine a transmitting power of the k^{th} Co-AP (e.g., AP 304). The multiplication factor αⱼ^{(k)} may be computed based on an interference that the k^{th} Co-AP (e.g., AP 304) may cause at the j^{th} scheduled STA (e.g., STA 306), where 0≤αⱼ^{(k)}≤1, j=1, . . . , N and k=1, . . . , K, such that:

$${\sum }_{k = 1}^{K} {r}_{j}^{( k )} {α}_{j}^{( k )} \leq {10}^{( \frac{{I}_{j}}{10} )} \qquad ( 2 )$$

As previously discussed, the rⱼ^{(k)} is the RSSI of the beacon frame of the k^{th} Co-AP (e.g., AP 304) which is received at the j^{th} scheduled STA (e.g., STA 306) of the TXOP owner AP 302. In certain non-limiting embodiments, the rⱼ^{(k)} may be calculated by the j^{th} scheduled STA (e.g., STA 306) from the latest beacon frame transmitted by the k^{th} Co-AP (e.g., AP 304). In certain non-limiting embodiments, the rⱼ^{(k)} may be extracted, by the TXOP owner AP 302, from the Radio Measurement Report frames received from the j^{th} scheduled STA (e.g., STA 306), each Radio Measurement Report frame providing a Beacon report, the Beacon report includes radio measurements of beacon frames received by the j^{th} scheduled STA from surrounding APs. In case the k^{th} Co-AP (e.g., AP 304) is not included in the received Radio Measurement Report frames the value of rⱼ^{(k)} may be equal to zero.

The RSSI rⱼ^{(k)} may be known to the TXOP owner AP 302 from the Radio Measurement Report frame sent to the TXOP owner AP 302 by the j^{th} scheduled STA (e.g., STA 306). Since the beacon frames may be transmitted at the maximum transmit power of k^{th} Co-AP (e.g., AP 304), the left-hand side of equation 2, may be the sum of the reduced interference power received at the j^{th} scheduled STA (e.g., STA 306). This reduced interference power received at the j^{th} scheduled STA (e.g., STA 306) may be less than or equal to the maximum allowed interference Iⱼ at the j^{th} scheduled STA (e.g., STA 306).

To this end, for the k^{th} Co-AP (e.g., AP 304), k=1, . . . , K, the TXOP owner AP 302 may compute the power reduction parameter Aₖ, which may represent a reduction in the maximum transmit power of the k^{th} Co-AP (e.g., AP 304) that may be required for the k^{th} Co-AP (e.g., AP 304) to participate in Co-SR. The power reduction parameter Aₖ may be computed based on a minimum value of multiplication factor αⱼ^{(k)} for all scheduled STAs, (e.g., STA 306 and 308). The power reduction parameter Aₖ may be given by:

$${A}_{k} = 10 log ( {min}_{j} {α}_{j}^{( k )} ) \qquad ( 3 )$$

Where, Aₖ may be the minimum value of the multiplication factor αⱼ^{(k)} for all j=1, . . . , N and expressed in dB scale.

After calculating the power reduction parameter Aₖ for all Co-APs (e.g., AP 304), the process 400 may proceed to step 406 where the TXOP owner AP 302 may select, based on the corresponding power reduction parameter Aₖ, a subset of Co-APs from the set of Co-APs for the Co-SR.

In certain non-limiting embodiments, if the power reduction parameter Aₖ>−∞ (or equivalently if

$${min}_{j} {α}_{j}^{( k )} > 0 ) ,$$

the k^{th} Co-AP (e.g., AP 304) may be selected for the Co-SR. In other words, not all Co-APs near the TXOP owner AP 302 may participate in the Co-SR rather, the Co-APs that satisfies the above condition may be included in the subset of Co-APs that may participate in the DL transmission along with the TXOP owner AP 302.

In certain non-limiting embodiments, the power reduction parameter Aₖ, corresponding to a k^{th} Co-APs (e.g., AP 304) of the subset of Co-APs may be computed based on the minimum value of multiplicative constants αⱼ^{(k)} computed for the set of scheduled STAs, such that a power of the DL transmission from the k^{th} Co-APs (e.g., AP 304) may be reduced based on the power reduction parameter, Aₖ, such that an overall interference level at the j^{th} scheduled STA (e.g., STA 306) may not exceed the allowable interference level Iⱼ.

After selecting the subset of Co-APs, the process 400 advances to step 408, where the TXOP owner AP 302 may transmit a Co-trigger frame towards the selected subset of Co-APs. In certain non-limiting embodiments, the Co-trigger frame may include i) the power reduction parameter corresponding to the APs included in the subset of Co-APs, ii) a predetermined DL transmission start time, and iii) a predetermined maximum DL transmission duration. In certain non-limiting embodiments, the DL transmission start time and the maximum DL transmission duration may be predetermined by the TXOP owner AP 302 prior to Co-SR.

The DL transmission start time may represent a time at which the TXOP owner AP 302 and the Co-AP (e.g., AP 304) selected for Co-SR may start DL transmission. The TXOP owner AP 302 may perform DL transmission in parallel. However, a power of the DL transmission of the Co-AP (e.g., AP 304) may be adjusted in accordance with the power reduction parameter Aₖ.

The maximum DL transmission duration may represent a maximum duration during which the TXOP owner AP 302 and the Co-AP (e.g., AP 304) may perform DL transmission over same bandwidth and same time.

In certain non-limiting embodiments, the DL transmission start time may be equal to a sum of Co-trigger frame end time and short inter-frame spacing time (SIFS). By way of example, the SIFS may be of the order of microseconds such as 10 or 16 microseconds. The maximum DL transmission duration may depend on the number of packets to be transmitted by the TXOP owner AP 302 and the data rate (data bits/s).

In certain non-limiting embodiments, the maximum allowed interference Iⱼ at the j^{th} scheduled STA (e.g., STA 306) may be controlled by controlling the minimum required SINR, Sⱼ, which in turn may be controlled by selection of the MCS index. A lower value of MCS index may require a lower SINR value Sⱼ which may allow a larger maximum allowed interference Iⱼ at the j^{th} scheduled STA (e.g., STA 306). Consequently, with reference to equation (2), the value of αⱼ^{(k)} may be increased which in-turn allows the k^{th} Co-AP (e.g., AP 304) to transmit at larger power and increase a possibility for the k^{th} Co-AP (e.g., AP 304) to participate in the Co-SR process. This, in turn, may reduce the channel access delay of the k^{th} Co-AP (e.g., AP 304). It is to be noted that, lowering the MCS index may increase the PPDU transmission time of the TXOP owner AP 302. Therefore, there may be a trade-off between gain in channel access delay and increase in PPDU transmit duration. By controlling Iⱼ (based on the MCS index) and αⱼ^{(k)}, ∀j, k in equation 2, the TXOP owner AP 302 may balance the trade-off between the increase in PPDU transmission duration and the reduction in channel access delay of other Co-APs (e.g. AP 304) via Co-SR.

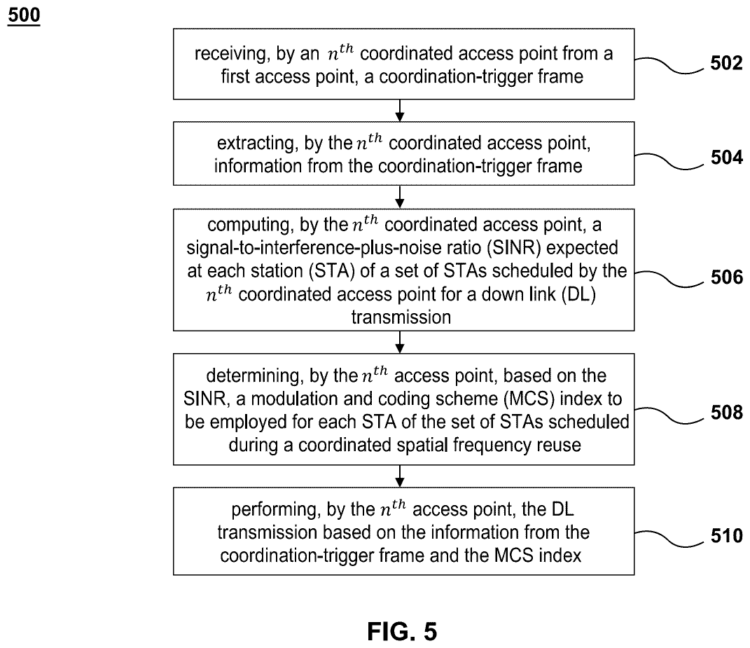

FIG. 5 depicts a process 500 representing a method for wireless communication, in accordance with various non-limiting embodiments of the present disclosure. In certain non-limiting embodiments, the process 500 may be implemented on one of the Co-AP (e.g., AP 304) selected by the TXOP owner AP 302 for the Co-SR. It is to be noted that out of K Co-APs, the TXOP owner AP 302 may select Co-APs based on the power reduction parameter Aₖ. The Co-AP onto which the process 500 is implemented may be represented as n^{th} Co-AP (e.g., AP 304). The n^{th} Co-AP (e.g., AP 304) may be one of the Co-APs selected by TXOP owner AP 302 based on the power reduction parameter Aₖ. As shown, the process 500 commences at step 502 where the n^{th} Co-AP (e.g., AP 304) receives the Co-trigger frame from the TXOP owner AP 302.

As previously noted, based on the power reduction parameter Aₖ∀k∈K, the TXOP owner AP 302 may select a subset of Co-APs from the set of K Co-APs. Also, as discussed previously, the TXOP owner AP 302 may transmit Co-trigger frame towards the subset of Co-APs. To this end, the n^{th} Co-AP (e.g., AP 304) that may be included in the subset of Co-APs may receive the Co-trigger frame from the TXOP owner AP 302.

The process 500 proceeds to step 504 where the n^{th} Co-AP (e.g., AP 304) extracts information from the Co-trigger frame. In certain non-limiting embodiments, the information in the coordination-trigger frame may include i) the power reduction parameter Aₖ∀k∈Q, Q may be a set of indices of the subset of Co-APs, ii) the predetermined DL transmission start time, and iii) the predetermined maximum DL transmission duration.

The process 500 advances to step 506 where the n^{th} Co-AP (e.g., AP 304) computes SINR expected at each station (STA) of a set of STAs (e.g., STAs 310 and 312) scheduled by the n^{th} Co-AP (e.g., AP 304) for the downlink (DL) transmission.

In certain non-limiting embodiments, the n^{th} Co-AP (e.g., AP 304) may compute a SINR Pₘ expected at a m^{th} scheduled STA (e.g., STA 310) associated with the n^{th} Co-AP (e.g., AP 304). That is, for the m^{th} scheduled STA (e.g., STA 310), the SINR value Pₘ, m=1, . . . , L may be computed as follows:

$${P}_{m} = {R}_{m} - {A}_{n} - 10 log {\sum }_{{k ∈ Q}_{k \neq n}} {r}_{m}^{( k )} {10}^{( \frac{{A}_{k}}{10} )} - M \qquad ( 4 )$$

The RSSI Rₘ may be calculated by the m^{th} scheduled STA (e.g., STA 310) from a first beacon frame broadcast by the n^{th} Co-AP (e.g., AP 304). Further, the RSSI Rₘ may be received by the n^{th} Co-AP (e.g., AP 304) in a Radio Measurement Report frame from the m^{th} scheduled STA (e.g., STA 310), including a Beacon report, providing radio measurements of beacon frames received by the m^{th} scheduled STA.

Q may be a set of indices of the subset of Co-APs including the n^{th} Co-AP (e.g., AP 304) and the TXOP owner AP 302 selected for the Co-SR.

rₘ^{(k)} may be an RSSI calculated by the m^{th} scheduled STA (e.g., STA 310) from a second beacon frame broadcast by a k^{th} Co-AP, k∈Q, k≠n. The RSSI rₘ^{(k)} may be extracted by the n^{th} Co-AP (e.g., AP 304) from the beacon report included in the Radio Measurement Report frame received from the m^{th} scheduled STA (e.g., STA 310). Also, rₘ^{(k)}=0, in case the k^{th} Co-AP, k∈Q, k≠n may not be included in the beacon report.

Aₙ may be corresponding to the power reduction parameter for the n^{th} Co-AP (e.g., AP 304), as determined by the TXOP owner AP 302. Aₖ may be the corresponding power reduction parameter for the k^{th} Co-AP, as determined by the TXOP owner AP 302 for all k∈Q, and M may be a margin to account for RSSI Rₘ variations.

After computing the SINR Pₘ, the process 500 proceeds to step 508 where the n^{th} Co-AP (e.g., AP 304) determines a MCS index to be employed for each scheduled STA included in the set of STAs during the Co-SR. The n^{th} Co-AP (e.g., AP 304) may select the MCS based on the SINR Pₘ. By way of example, the n^{th} Co-AP (e.g., AP 304) may maintain a look up table corresponding to the expected values of the SINR Pₘ and the corresponding MCS index.

Finally, the process 500 advances to step 510 where the n^{th} Co-AP (e.g., AP 304) performs the DL transmission based on the information extracted from the Co-trigger frame and the determined MCS index. As previously discussed, one of the parameters included in the Co-trigger frame is the power reduction parameter Aₙ. The n^{th} Co-AP (e.g., AP 304), if selected for Co-SR, may reduce a power of the DL transmission from the n^{th} Co-AP (e.g., AP 304) towards the m^{th} scheduled STA (e.g., STA 310) based on the power reduction parameter Aₙ.

Further, in certain non-limiting embodiments, the n^{th} Co-AP (e.g., AP 304) may start the DL transmission towards the m^{th} scheduled STA (e.g., STA 310) based on the DL transmission start time included in the Co-trigger frame. Also, in certain non-limiting embodiments, the DL transmission may be performed in such a manner that a start and an end of the DL transmission may be defined by the DL transmission start time and the maximum DL transmission duration derived from the Co-trigger frame. In other words, the n^{th} Co-AP (e.g., AP 304) may perform the DL transmission during the start and end times of the Co-SR derived from the Co-trigger frame.

In certain non-limiting embodiments, the DL transmission performed by the n^{th} Co-AP (e.g., AP 304) may request the set of scheduled STAs (e.g., STA 310 and 312) not to transmit any response frame during the Co-SR.

In certain non-limiting embodiments, the DL transmission performed by the n^{th} Co-AP (e.g., AP 304) may request the set of scheduled STAs (e.g., STA 310 and 312) to delay a transmission of any response frame during the Co-SR.

In certain non-limiting embodiments, the DL transmission performed by the n^{th} Co-AP (e.g., AP 304) may not elicit any response frame from the set of scheduled STAs (e.g., STA 310 and 312) during the Co-SR.

In certain non-limiting embodiments, after the DL transmission within the maximum DL transmission duration, the n^{th} Co-AP (e.g., AP 304) may transmit block acknowledgment request (BAR) frames towards the set of scheduled STAs (e.g., STA 310 and 312) to request a transmission of acknowledgment frames from the set of scheduled STAs (e.g., STA 310 and 312) towards the n^{th} Co-AP (e.g., AP 304). In so doing, the n^{th} Co-AP (e.g., AP 304) may avoid any interference from the acknowledgment frames of its set of scheduled STAs (e.g., STA 310 and 312) to the transmission performed by the TXOP owner AP 302 during the Co-SR.

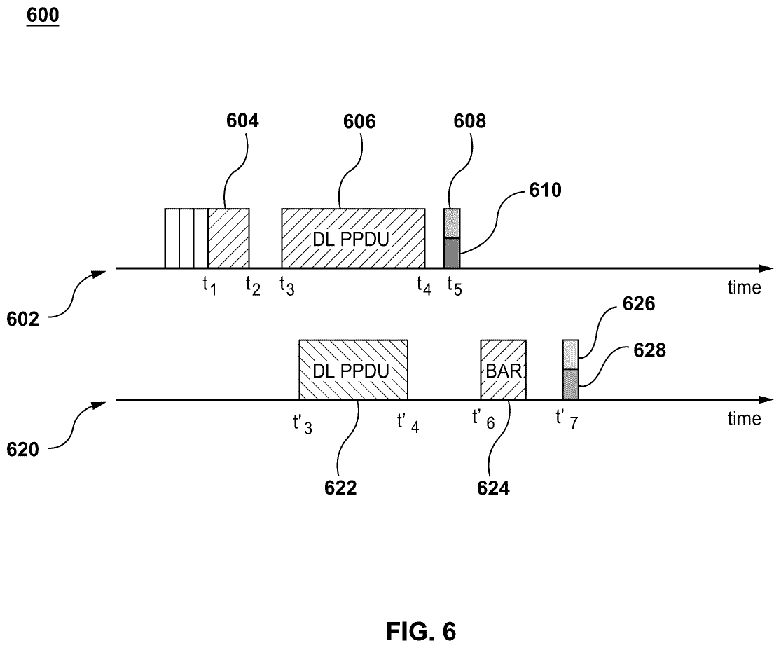

FIG. 6 illustrates a representative timeline 600 corresponding to the DL PPDU transmissions by the TXOP owner AP (e.g., AP 302) and the k^{th} Co-AP (e.g., AP 304), in accordance with various non-limiting embodiments of the present disclosure. As shown, a timeline 602 may correspond to the TXOP owner AP (e.g., AP 302) and a timeline 620 may correspond to the k^{th} Co-AP (e.g., AP 304). As shown in the timeline 602, between time t₁ and t₂, the TXOP owner AP (e.g., AP 302) may transmit a Co-trigger frame 604 to various Co-APs. In between time t₃ and t₄, the TXOP owner AP (e.g., AP 302) may transmit DL PPDU frames 606 towards the associated STAs (e.g., STAs 306 and 308). At time t₅, the associated STAs (e.g., the STA 306 and 308) may transmit acknowledgment signals 608 and 610 towards the TXOP owner AP (e.g., AP 302). It is to be noted that the timeline 602 may not be linear and only illustrates a sequence of events. Further, the time events may not be a representative of a duration of each operation.

Further, as shown in timeline 620, based on the Co-trigger frame 604, the k^{th} Co-AP (e.g., AP 304) may begin transmission of DL PPDU frames 622 towards the associated STAs (e.g., STAs 310 and 312) between time t′₃ and t′₄. It is to be noted that the k^{th} Co-AP (e.g., AP 304) may finish the transmission of the DL PPDU frames 622 within the duration of the DL PPDU frames 606. In other words, the duration between the time t′₃ and t′₄ may be less than equal to the maximum DL transmission time. Further, the time t′₃ may be same as the time t₃ (of timeline 602) or may come after the time t₃ and the time t′₄ may be same as the time t₄ (of timeline 602) or may come before the time t₄. Additionally, to avoid any interference between the ongoing transmission between the TXOP owner AP (e.g., AP 302) and the associated STAs (e.g., STAs 306 and 308), the k^{th} Co-AP (e.g., AP 304) may request the set of scheduled STAs (e.g., STA 310 and 312) not to transmit any acknowledgment frame during the Co-SR. After the end of the Co-SR duration, the k^{th} Co-AP transmits BAR frames 624 at time t′₆. The BAR frames request transmission of acknowledgment frames from the associated STAs (e.g., STAs 310 and 312). To this end, the associated STAs (e.g., STAs 310 and 312) may transmit delayed acknowledgments 626 and 628 at time t′₇. Also, similar to the timeline 602, the timeline 620 may not be linear and only illustrates a sequence of events. Further, the time events may not be a representative of a duration of each operation.

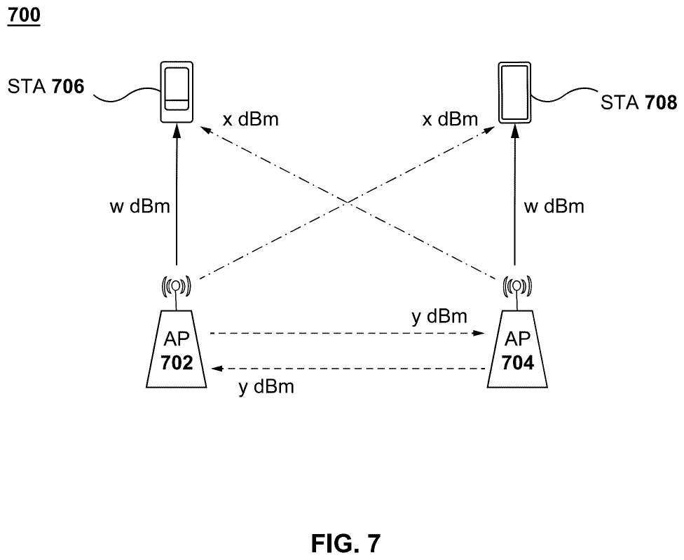

FIG. 7 illustrates another portion 700 of the WLAN 100, in accordance with various non-limiting embodiments of the present disclosure. As shown, another portion 700 may include APs 702 and 704, STAs 706, and 708. The STAs 706 and 708 may be associated with the AP 702 and 704 respectively. It is contemplated that the APs 702 and 704 may be implemented in a similar manner to the AP 102 and the STAs 706, and 708 may be implemented in a similar manner to the AP 102 as previously discussed in FIG. 1B.

In FIG. 7, a strength of the desired received signals from the APs (e.g., AP 702 or 704) to the associated STAs (e.g., AP 706 or 708) may be represented by w dBm. A strength of an interference from the AP (e.g., AP 702) to a non-associated STA (e.g., STA 708) may be represented by x dBm. Also, a strength of an interference from one AP (e.g., AP 702) to another AP (e.g., AP 704) may be represented by y dBm.

Different simulation scenarios for the performance evaluation of another portion 700 of the WLAN 100 are shown in Table 2.

TABLE 2
Simulation Scenarios

| | | | | MCS for | MCS for |
|---|---|---|---|---|---|
| | | | | AP 702 and | AP 702 and |
| | | | | AP 704 | AP 704 |
| | x | y | w | (without | (with |
| Scenario # | (dBm) | (dBm) | (dBm) | Co-SR) | Co-SR) |
| 1 | −80 | −80 | −35 | 11 | 11 |
| 2 | −80 | −80 | −41 | 11 | 11 |
| 3 | −80 | −80 | −46 | 11 | 9 |
| 4 | −80 | −80 | −52 | 11 | 7 |
| 5 | −80 | −80 | −58 | 11 | 4 |
| 6 | −78 | −78 | −35 | 11 | 11 |
| 7 | −74 | −74 | −35 | 11 | 11 |
| 8 | −70 | −70 | −35 | 11 | 9 |
| 9 | −67 | −67 | −35 | 11 | 9 |
| 10 | −62 | −62 | −35 | 11 | 7 |
| 11 | −58 | −58 | −35 | 11 | 5 |

In scenarios 1 through 5, the RSSI (w dBm) from AP 702 to STA 706 and from AP 704 to STA 708 decreases. In scenarios 6 through 11, the interference (x dBm) from AP 702 to STA 708 and from AP 704 to STA 706 increases. Some representative parameters considered for simulations are shown in Table 3.

TABLE 3
Simulation parameters

| Parameter | Settings |
|---|---|
| Channel bandwidth | 40 MHZ |
| MPDU arrival process | exponential |
| | on-off |
| Downlink application layer traffic | 20-70 Mbps |
| generation rate for each STA | |
| associated with a Co-AP, denoted by r | |
| MSDU size | 1500 bytes |
| Maximum aggregate-MPDU size | 256 MPDUs |
| TXOP limit | 4 ms |

Table 4 illustrates a peak aggregate goodput of the network for some simulation scenarios.

TABLE 4
Peak aggregate goodput

| | | Scenario index | | | | |
|---|---|---|---|---|---|---|
| | | 1, 2, 6, | 3, 8, | | | |
| | | and 7 | and 9 | 4 and 10 | 11 | 5 |
| Channel | No Co-SR | 217.2 | | | | |
| access | Co-SR | 407.9 | 330.5 | 216.8 | 216.8 | 216.8 |
| method | | | | | | |

| | | | | | |
|---|---|---|---|---|---|
| Increase in peak | 88% | 52% | ~0% | ~0% | ~0% |
| aggregate goodput | | | | | |
| due to Co-SR (%) | | | | | |

In scenarios 1, 2, 6 and 7, the techniques disclosed in the present disclosure may provide very high increase in goodput when Co-SR techniques may be employed. In these scenarios, the RSSI at the destination STAs is high and the interference from the overlapping APs is low. In scenarios 3, 8 and 9, the increase in goodput is also high. In scenarios 4,5,10, and 11, the Co-SR technique is not employed due to either higher interference from the APs or lower RSSI value at the destination STAs and therefore there is no gain in goodput.

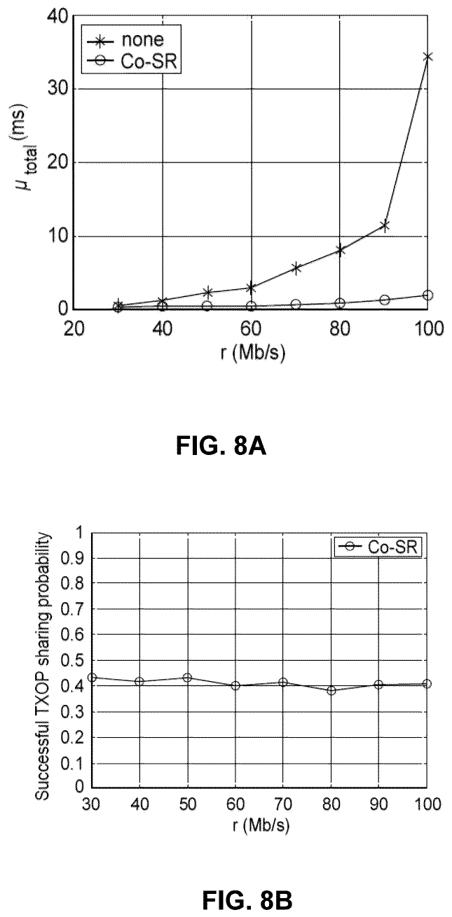

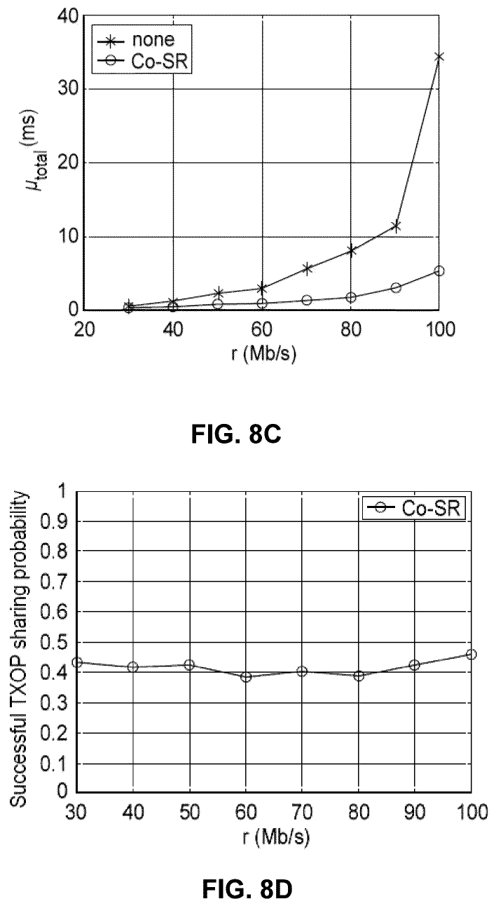

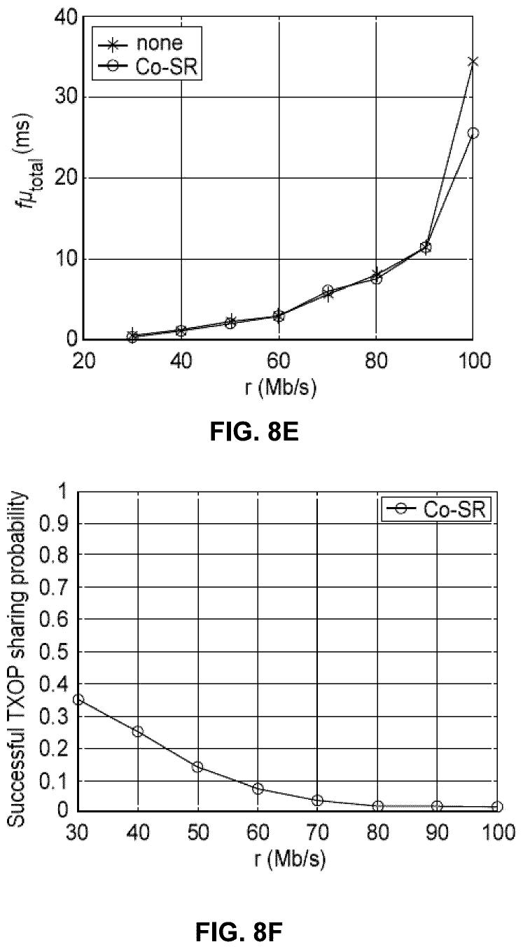

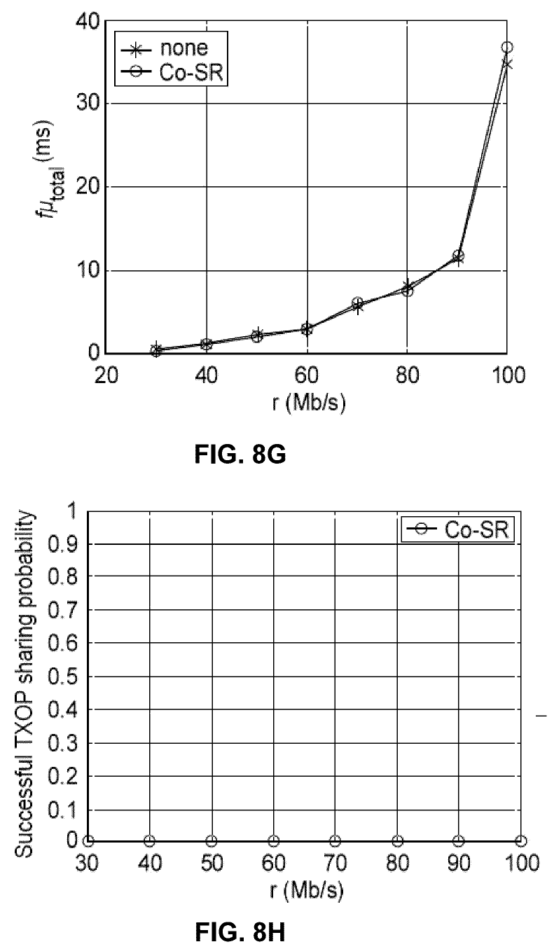

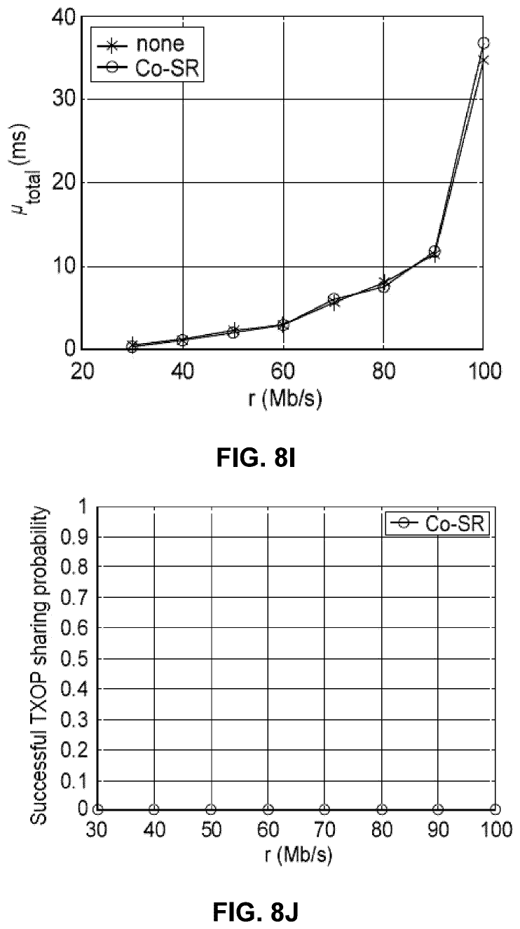

FIGS. 8A-8J illustrate an average packet delivery delay and a probability of a successful Co-SR attempt for various simulation scenarios, in accordance with various non-limiting embodiments of the present disclosure. FIGS. 8A and 8B illustrate the average packet delivery delay and the probability of a successful Co-SR attempt respectively for scenarios 1, 2, 6 and 7. FIGS. 8C and 8D illustrate the average packet delivery delay and the probability of a successful Co-SR attempt respectively for scenarios 3, 8, and 9. FIGS. 8E and 8F illustrate the average packet delivery delay and the probability of a successful Co-SR attempt respectively for scenarios 4 and 10. FIGS. 8G and 8H illustrate the average packet delivery delay and the probability of a successful Co-SR attempt respectively for scenario 11. FIGS. 8I and 8J illustrate the average packet delivery delay and the probability of a successful Co-SR attempt respectively for scenario 5.

As noted from the FIG. 8A-8J, the average packet delivery delay for scenarios 1, 2, 3, 6, 7, 8 and 9 are reduced significantly due to high probability of successful Co-SR attempt.

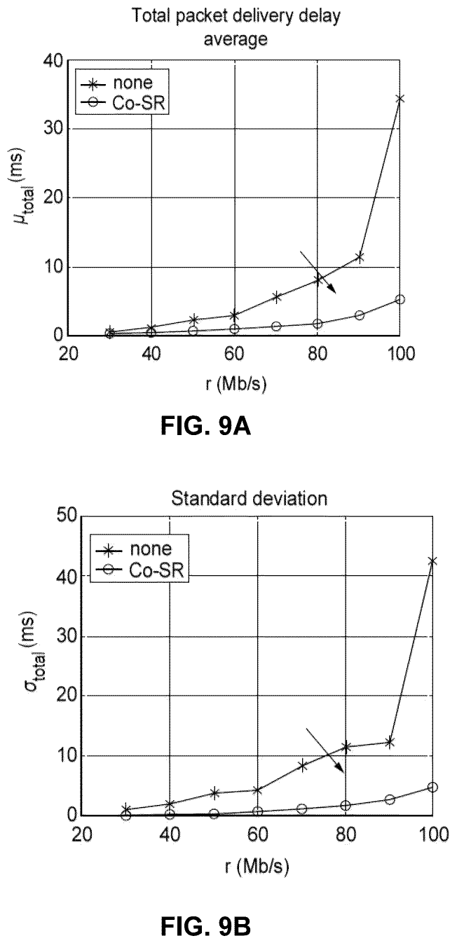

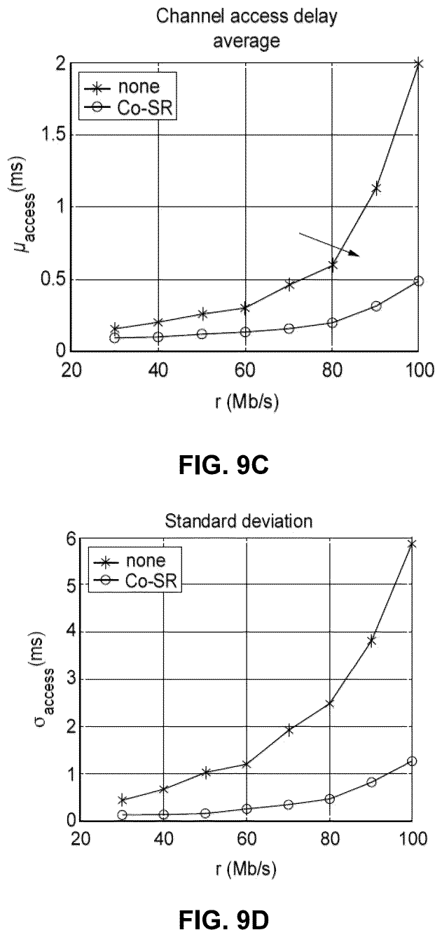

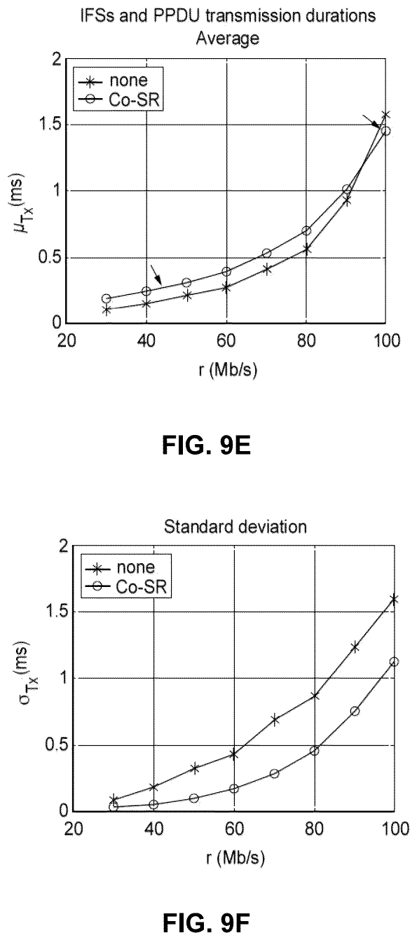

FIGS. 9A-9F illustrate detailed investigation of scenarios 3, 8 and 9, in accordance with various non-limiting embodiments. FIGS. 9A and 9B illustrate representative scenarios of a total packet delivery delay average and a corresponding standard deviation respectively. As shown, due to various techniques disclosed in the present disclosure, there is a significant improvement in total packet delivery delay average and the corresponding standard deviation.

FIGS. 9C and 9D illustrate representative scenarios of channel access delay average and a corresponding standard deviation respectively. As shown, due to various techniques disclosed in the present disclosure, channel access delay average and the standard deviation are reduced significantly due to simultaneous access to the medium (bandwidth and time) by APs. However, the PPDU DL transmission duration may be slightly increased due to using lower MCS or lower transmit power by the APs. The significant reduction in the average and standard deviation of the total packet delivery delay (as shown in FIGS. 9A and 9B) may result in a considerable reduction in the worst-case packet delivery delay, e.g., 99th percentile of the delay. FIGS. 9E and 9F illustrate representative scenarios of Interframe-spaces (IFSs) and PPDU transmission duration average and a corresponding standard deviation respectively.

It will be understood that, although the embodiments presented herein have been described with reference to specific features and structures, it is clear that various modifications and combinations may be made without departing from such disclosures. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A wireless communication method comprising:
computing, by a first access point, an allowable interference level for each station (STA) of a set of STAs scheduled by the first access point for a downlink (DL) transmission;
computing, by the first access point, based on the allowable interference level for each scheduled STA, a corresponding power reduction parameter for each access point of a set of coordinated access points;
selecting, by the first access point, based on the corresponding power reduction parameter, a subset of coordinated access points from the set of coordinated access points for a coordinated spatial frequency reuse; and
transmitting, by the first access point, a coordination-trigger frame towards the subset of coordinated access points, wherein the coordination-trigger frame includes:
the power reduction parameters corresponding to the access points included in the subset of coordinated access points,
a predetermined DL transmission start time, and
a predetermined maximum DL transmission duration.

2. The wireless communication method of claim 1, wherein an allowable interference level, Iⱼ, corresponding to a j^{th} scheduled STA of the set of scheduled STAs is computed from (i) a received signal strength indicator (RSSI) Rⱼ received by the first access point in Radio Measurement Report frames from the j^{th} scheduled STA, each Radio Measurement Report frame providing a Beacon report, the Beacon report includes radio measurements of a beacon frame broadcast by the first access point, (ii) a required minimum value of DL signal-to-interference-plus-noise ratio (SINR) Sⱼ, at the j^{th} scheduled STA, and (iii) a margin M to account for RSSI Rⱼ variations.

3. The wireless communication method of claim 2, wherein the allowable interference level Iⱼ is given by:
$${I}_{j} = {R}_{j} - {S}_{j} - M ,$$
where the Iⱼ and Rⱼ values are indicated in dBm and the Sⱼ value is indicated in dB.

4. The wireless communication method of claim 2, wherein the RSSI Rⱼ is stored in a management information base (MIB) of the first access point.

5. The wireless communication method of claim 2, wherein a power reduction parameter, Aₖ, corresponding to a k^{th} coordinated access point of the subset of coordinated access points is computed based on a minimum value of multiplicative constants αⱼ^{(k)} computed for the set of scheduled STAs, such that a power of the DL transmission from the k^{th} coordinated access point is reduced based on the power reduction parameter, Aₖ and an overall interference level at the j^{th} scheduled STA does not exceed the allowable interference level Iⱼ.

6. The wireless communication method of claim 5, wherein the power reduction parameter Aₖ is computed by:
computing a multiplicative constant αⱼ^{(k)} for a transmit power of the k^{th} coordinated access point, such that:
$${\sum }_{k = 1}^{K} {r}_{j}^{( k )} {α}_{j}^{( k )} \leq {10}^{( \frac{{I}_{j}}{10} )}$$
where the rⱼ^{(k)} is an RSSI at the j^{th} scheduled STA corresponding to a beacon frame broadcast by the k^{th} coordinated access point, the rⱼ^{(k)} is extracted, by the first access point, from the Radio Measurement Report frames received from the j^{th} scheduled STA, or rⱼ^{(k)}=0, in case the k^{th} coordinated access point is not included in the Radio Measurement Report frames,
K is a total number of coordinated access points in the set of coordinated access points located near the first access point, and
a value of αⱼ^{(k)} is such that 0≤αⱼ^{(k)}≤1, j=1, . . . , N, N is a total number of STAs in the set of scheduled STAs; and
computing the power reduction parameter Aₖ, in dB, based on 10 log
$$( {min}_{j} {α}_{j}^{( k )} ) .$$

7. The wireless communication method of claim 6, wherein when
$${min}_{j} {α}_{j}^{( k )} > 0$$
for the k^{th} coordinated access point, the k^{th} coordinated access point is selected by the first access point for a coordinated spatial frequency reuse.

8. The wireless communication method of claim 1, wherein the first access point obtains a channel access via channel contention among K+1 coordinated access points, for transmission of data for a given duration over a given bandwidth, wherein K is a total number of coordinated access points in the set of coordinated access points located near the first access point.

9. A wireless communication system comprising:
a first access point configured to:
compute an allowable interference level for each station (STA) of a set of STAs scheduled by the first access point for a downlink (DL) transmission;
compute, based on the allowable interference level for each scheduled STA, a corresponding power reduction parameter for each access point of a set of coordinated access points;
select, based on the corresponding power reduction parameter, a subset of coordinated access points from the set of coordinated access points for a coordinated spatial reuse; and
transmit a coordination-trigger frame towards the subset of coordinated access points, wherein the coordination-trigger frame includes:
the power reduction parameters corresponding to the access points included in the subset of coordinated access points,
a predetermined DL transmission start time, and
a predetermined maximum DL transmission duration.

10. The wireless communication system of claim 9, wherein an allowable interference level, Iⱼ, corresponding to a j^{th} scheduled STA of the set of scheduled STAs is computed from (i) a received signal strength indicator (RSSI) Rⱼ received by the first access point in Radio Measurement Report frames from the j^{th} scheduled STA, each Radio Measurement Report frame providing a Beacon report, the Beacon report includes radio measurements of a beacon frame broadcast by the first access point, (ii) a required minimum value of DL signal-to-interference-plus-noise ratio (SINR) Sⱼ, at the j^{th} scheduled STA, and (iii) a margin M to account for RSSI Rⱼ variations.

11. The wireless communication system of claim 10, wherein the allowable interference level Iⱼ is given by:
$${I}_{j} = {R}_{j} - {S}_{j} - M ,$$
where the Iⱼ and Rⱼ values are indicated in dBm and the Sⱼ value is indicated in dB.

12. The wireless communication system of claim 10, wherein the RSSI Rⱼ is stored in a management information base (MIB) of the first access point.

13. The wireless communication system of claim 10, wherein a power reduction parameter, Aₖ, corresponding to a k^{th} coordinated access point of the subset of coordinated access points is computed based on a minimum value of multiplicative constants αⱼ^{(k)} computed for the set of scheduled STAs, such that a power of the DL transmission from the k^{th} coordinated access point is reduced based on the power reduction parameter, Aₖ and an overall interference level at the j^{th} scheduled STA does not exceed the allowable interference level Iⱼ.

14. The wireless communication system of claim 13, wherein the power reduction parameter Aₖ is computed by:
computing a multiplicative constant αⱼ^{(k)} for a transmit power of the k^{th} coordinated access point, such that:
$${\sum }_{k = 1}^{K} {r}_{j}^{( k )} {α}_{j}^{( k )} \leq {10}^{( \frac{{I}_{j}}{10} )}$$
where the rⱼ^{(k)} is an RSSI at the j^{th} scheduled STA corresponding to a beacon frame broadcast by the k^{th} coordinated access point, the rⱼ^{(k)} is extracted, by the first access point, from the Radio Measurement Report frames received from the j^{th} scheduled STA, or rⱼ^{(k)}=0, in case the k^{th} coordinated access point is not included in the Radio Measurement Report frames,
K is a total number of coordinated access points in the set of coordinated access points located near the first access point, and
a value of αⱼ^{(k)} is such that 0≤αⱼ^{(k)}≤1, j=1, . . . , N, N is a total number of STAs in the set of scheduled STAs; and
computing the power reduction parameter Aₖ, in dB, based on 10 log
$$( {min}_{j} {α}_{j}^{( k )} ) .$$

15. The wireless communication system of claim 14, wherein when
$${min}_{j} {α}_{j}^{( k )} > 0$$
for the k^{th} coordinated access point, the k^{th} coordinated access point is selected by the first access point for a coordinated spatial frequency reuse.

16. The wireless communication system of claim 9, wherein the first access point obtains a channel access via channel contention among K+1 coordinated access points, for transmission of data for a given duration over a given bandwidth, wherein K is a total number of coordinated access points in the set of coordinated access points located near the first access point.

17. A coordinated access point comprising:
a non-transitory memory element having instructions thereon;
a processor coupled to the non-transitory memory element and execute the instructions to cause the coordinated access point to:
compute an allowable interference level for each station (STA) of a set of STAs scheduled by the first access point for a downlink (DL) transmission;
compute, based on the allowable interference level for each scheduled STA, a corresponding power reduction parameter for each access point of a set of coordinated access points;
select, based on the corresponding power reduction parameter, a subset of coordinated access points from the set of coordinated access points for a coordinated spatial reuse; and
transmit a coordination-trigger frame towards the subset of coordinated access points,
wherein the coordination-trigger frame includes:
the power reduction parameters corresponding to the access points included in the subset of coordinated access points,
a predetermined DL transmission start time, and
a predetermined maximum DL transmission duration.
